(19) United States
(12) Patent Application Publication
(10) Pub. No.: US 2025/0135342 A1
(43) Pub. Date: May 1, 2025

(54) SYSTEMS AND METHODS FOR ACTIVATING AND DISPLAYING FEATURES IN PLAYER-VERSUS-PLAYER MATCHUPS

(71) Applicant: Aristocrat Technologies, Inc., Las Vegas, NV (US)

(72) Inventors: Jussi Lassila, Espoo (FI); Bruno Malta de La Plata, Espoo (FI); Minu Lee, Las Vegas, NV (US); Kari Kuvaja, Las Vegas, NV (US)

(21) Appl. No.: 18/651,595

(22) Filed: Apr. 30, 2024

Related U.S. Application Data
(60) Provisional application No. 63/593,173, filed on Oct. 25, 2023.

(51) Int. Cl. A63F 13/537; A63F 13/58; A63F 13/67; G06T 15/00

(52) U.S. Cl. CPC A63F 13/537; A63F 13/58; A63F 13/67; G06T 15/00; G06T 2200/24

(57) ABSTRACT

A system for activating and displaying features in PVP matchups. In one example, the system may include and/or implement circuitry configured to activate a reserve skill of a character involved in a PVP match of a video game. In this example, the system may include and/or implement a graphics processing unit (GPU) configured to render a user interface that presents a set of digital elements corresponding to the PVP match. The GPU may be further configured to render, in the user interface, a graphical representation of an action associated with the reserve skill of the character. Various other devices, systems, and methods are also disclosed.

### PRIORITY CLAIM

This application claims priority to U.S. Provisional Application No. 63/593,173 filed Oct. 25, 2023, the disclosure of which is incorporated in its entirety by this reference.

### BACKGROUND

Certain gaming systems may enable players to interact with one another over a network. For example, a gaming system may provide and/or implement a multiplayer video game involving multiple players located remotely from one another. In this example, the gaming system may include and/or represent multiple clients operated by the players matched up against one another and a server that coordinates inputs, instructions, and/or commands submitted by the players for integration into a single game environment.

In certain types of video games, the gaming systems may apply different features to the game environment. For example, a gaming system may provide and/or implement a video game that involves a player-versus-player (PVP) matchup in which players fight and/or defend against bot-controlled antagonists. In this example, the two players in the PVP matchup may compete with each other indirectly based on their relative performances against the bot-controlled antagonists. The instant disclosure identifies and addresses a need for systems and methods for activating and displaying features in such PVP matchups.

### SUMMARY

As will be described in greater detail below, the instant disclosure generally relates to systems and methods for activating and displaying features in PVP matchups. In one example, a system for accomplishing such a task may include and/or implement circuitry configured to activate a reserve skill of a character involved in a player-versus-player (PVP) match of a video game. In this example, the system may include and/or implement a graphics processing unit (GPU) configured to render a user interface that presents a set of digital elements corresponding to the PVP match. The GPU may be further configured to render, in the user interface, a graphical representation of an action associated with the reserve skill of the character.

In some examples, the circuitry may be further configured to apply the reserve skill of the character in the PVP match based at least in part on input received from a player controlling the character. Additionally or alternatively, the circuitry may be further configured to determine that a metric associated with the character has reached a certain threshold and then activate the reserve skill of the character in response to the metric reaching the certain threshold.

In some examples, the circuitry may be further configured to increase the metric associated with the character based at least in part on the performance of a player controlling the character and/or the passage of time. In one example, the circuitry may be further configured to apply the reserve skill of the character in a defensive context intended to prolong a duration of survival for a player side of the PVP match that involves the character.

In some examples, the GPU is further configured to render, in the user interface, one or more antagonists that move along a lane on the player side of the PVP match. In one example, the circuitry may be further configured to enable a player controlling the player side of the PVP match to prolong the duration of survival for the player side by utilizing the reserve skill of the character against the one or more antagonists that move along the lane on the player side. Additionally or alternatively, the circuitry may be further configured to apply the reserve skill of the character in an offensive context intended to reduce a duration of survival for an opponent side of the PVP match that does not directly involve the character.

In some examples, the GPU may be further configured to render, in the user interface, one or more antagonists that move along a lane on the opponent side of the PVP match. In one example, the circuitry may be further configured to enable a player controlling the player side of the PVP match to reduce the duration of survival for the opponent side by utilizing the reserve skill of the character in favor of the one or more antagonists that move along the lane on the opponent side.

In some examples, the circuitry may be further configured to apply the reserve skill of the character in both (1) a defensive context intended to prolong a duration of survival for a player side of the PVP match that involves the character and (2) an offensive context intended to reduce a duration of survival for an opponent side of the PVP match that does not directly involve the character. In one example, the GPU may be further configured to render, in the user interface, one or more antagonists that move along a lane on the player side of the PVP match. Additionally or alternatively, the GPU may be further configured to render, in the user interface, one or more additional antagonists that move along an additional lane on the opponent side of the PVP match. In this example, the circuitry may be further configured to enable a player controlling the player side of the PVP match to utilize the reserve skill of the character against the one or more antagonists and in favor of the one or more additional antagonists to both prolong the duration of survival for the player side and reduce the duration of survival for the opponent side.

In some examples, the circuitry may be further configured to activate an additional reserve skill of an additional character involved in the PVP match. In one example, the GPU may be further configured to render, in the user interface, a graphical representation of an additional action associated with the additional reserve skill of the additional character.

In some examples, the circuitry may be further configured to randomly select, from a set of modifiers, a modifier applicable to a feature of the PVP match. In one example, the GPU may be further configured to apply, at a predetermined time within the PVP match, the modifier to one or more of the digital elements to dynamically change a graphical representation of the feature in the user interface. In certain implementations, the feature of the PVP match may include and/or represent the character, one or more antagonists on a player side of the PVP match that involves the character, one or more antagonists on an opponent side of the PVP match that does not directly involve the character, and/or an obstruction that impedes one or more antagonists from achieving an objective.

In some examples, the modifier may last for a limited amount of time during the PVP match, and the GPU may be further configured to terminate the modifier applied to the one or more of the digital elements after the limited amount of time has lapsed during the PVP match. In certain examples, the circuitry may be further configured to periodically reapply the modifier to the one or more of the digital elements during the PVP match.

In some examples, the circuitry may be further configured to randomly select, from the set of modifiers, an additional modifier applicable to an additional feature of the PVP match. In one example, the GPU may be further configured to apply the modifier to the one or more of the digital elements at the predetermined time within a specific round of the PVP match. In this example, the GPU may be further configured to apply the additional modifier to another one of the digital elements to dynamically change a graphical representation of the additional feature at another predetermined time within the specific round of the PVP match.

In some examples, the predetermined time may correspond to a countdown timer implemented in connection with the PVP match. In one example, the GPU may be further configured to render, in the user interface, a graphical representation of the timer along with a notification of the modifier to be applied to the one or more of the digital elements.

Similarly, a corresponding computer-implemented method may include rendering, by a GPU, a user interface that presents a set of digital elements corresponding to a PVP match of a video game. In one example, the corresponding computer-implemented method may also include activating, by circuitry, a reserve skill of a character involved in the PVP match. In this example, the corresponding computer-implemented method may further include applying, by the circuitry, the reserve skill of the character in at least one of (1) a defensive context intended to prolong a duration of survival for a player side of the PVP match that involves the character and/or (2) an offensive context intended to reduce a duration of survival for an opponent side of the PVP match that does not directly involve the character. Additionally or alternatively, the corresponding computer-implemented method may include rendering, in the user interface, a graphical representation of an action associated with the reserve skill of the character.

In some examples, a non-transitory computer-readable medium that facilitates and/or implements the above-identified method may include one or more computer-executable instructions. When executed by at least one hardware processor of a computing device, the computer-executable instructions may cause the hardware processor to activate a reserve skill of a character involved in a PVP match of a video game. In one example, when executed by the hardware processor of the computing device, the computer-executable instructions may also cause the hardware processor to apply the reserve skill of the character in at least one of (1) a defensive context intended to prolong a duration of survival for a player side of the PVP match that involves the character and/or (2) an offensive context intended to reduce a duration of survival for an opponent side of the PVP match that does not directly involve the character. In this example, when executed by the hardware processor of the computing device, the computer-executable instructions may also cause the hardware processor to direct a graphics processing unit (GPU) to render a user interface that presents a set of digital elements corresponding to the PVP match and/or to render, in the user interface, a graphical representation of an action associated with the reserve skill of the character.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for activating and displaying features in player-versus-player (PVP) matchups according to one or more implementations of this disclosure.

FIG. 2 is a block diagram of an exemplary PVP match according to one or more embodiments of this disclosure.

FIG. 3 is an illustration of an exemplary user interface that presents digital elements of a PVP match involved in a video game according to one or more embodiments of this disclosure.

FIG. 4 is an illustration of an exemplary user interface that presents digital elements of a PVP match involved in a video game according to one or more embodiments of this disclosure.

FIG. 5 is an illustration of an exemplary user interface that presents digital elements of a PVP match involved in a video game according to one or more embodiments of this disclosure.

FIG. 6 is a flow diagram of an exemplary computer-implemented method for activating and displaying features in PVP matchups according to one or more implementations of this disclosure.

FIG. 7 is a block diagram of an exemplary implementation of a system for activating and displaying features in PVP matchups according to one or more embodiments of this disclosure.

FIG. 8 is a block diagram of an exemplary implementation of server-client system that facilitates coordinating and/or distributing portions of a video game that involves and/or implements player matchups with dynamically selected difficulty levels according to one or more embodiments of this disclosure.

FIG. 9 is a block diagram of an exemplary client device that facilitates displaying and/or presenting a video game that involves and/or implements player matchups with dynamically selected difficulty levels according to one or more embodiments of this disclosure.

Throughout the drawings, identical reference characters and descriptions may indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure describes various systems and methods for activating and displaying features in player-versus-player (PVP) matchups. As will be explained in greater detail below, embodiments of the present disclosure may improve the operation of computing systems when generating, coordinating, rendering, and/or displaying images that, in at least some cases, form part of a video game. In some examples, embodiments of the present disclosure may align, equalize, standardize, and/or shorten the duration of PVP matchups in a video game. For example, embodiments of the present disclosure may enable players to modify and/or alter strategies for the PVP matchups based at least in part on characters' reserve skills and/or randomly selected mid-matchup modifiers, thereby contracting and/or reducing the duration of the PVP matchups.

These improvements may manifest as and/or result in fewer central processing unit (CPU) cycles and/or GPU cycles to render the image frames, less memory being used during such rendering, and/or fewer communications transferred over hardware memory controllers and/or over hardware input/output (I/O) controllers. Additionally or alternatively, these improvements may enable a server to accommodate more of the gaming needs of client devices operated by a userbase.

In some examples, processing communications between players in a PVP game may be made more efficient on both the server side and the client side by having the PVP client devices process at least some of the game components asynchronously and only sending player actions to the server. For example, in a tower defense PVP game, the players may compete against each other by battling their respective antagonists. In one example, a server may be configured to process the battle only after having received actions from both players in the PVP battle. In this example, the server may then process the battle (e.g., by generating character positioning, character actions, character graphics information) up to the latest common timestamp between the players. Then, the server may send the validated player actions to the players' electronic devices. By doing so, the server may avoid performing game processing without receiving actions from the players, thereby conserving CPU cycles that would otherwise be spent processing synchronous content. Moreover, network traffic between players' devices and backend servers may be avoided partially or omitted entirely unless and until actions are taken by the respective players in the PVP battle.

Additionally or alternatively, gaming animations may be preprocessed and/or rendered into a texture to avoid time and GPU cycles that would otherwise be spent on calculating the underlying bone transformations for each frame. The pixels rendered into the texture may store, for each bone transformation, the transformation matrix for each video game frame. The GPU may read the bone transformation from the texture and then apply the information read from the bone transformation to the video game frame. By doing so, the GPU may provide and/or output a series of video game frames analogous to a flip-book style animation for a 3D mesh, which may then be used when generating video game content. These processes may effectively reduce the amount of GPU cycles used to process the video game, thereby decreasing the amount of network traffic sent and received between the server and client devices because the 3D mesh contains less data and is more efficient to transmit.

In some examples, a networked gaming system may facilitate, support, and/or provide a multiplayer video game that involves one or more PVP matches. In one example, the networked gaming system may include and/or represent a server and multiple client devices operated by the players of the multiplayer video game. In this example, the server and/or the client devices may include and/or represent circuitry (e.g., one or more hardware processors, CPUs, and/or integrated circuits) that activates and/or applies reserve skills of characters involved in the PVP matches. The reserve skills of the characters may be activated and/or applied in both defensive and offensive contexts of the PVP matches.

In some examples, the server and/or the client devices may also include one or more GPUs that render a user interface that presents a set of digital elements corresponding to the PVP match. In one example, the GPU may also render graphical representations of actions (e.g., attacks, defenses, mergers of characters and/or their skillsets, survival tactics, etc.) associated with the reserve skills of the characters in the user interface.

In some examples, the circuitry may randomly select, from a set of modifiers, certain modifiers applicable to features (e.g., characters, antagonists, obstructions, boards, arenas, etc.) of the PVP match. In one example, the GPU may apply, at predetermined times within the PVP match, the randomly selected modifiers to one or more of the digital elements to dynamically change graphical representations of those features in the user interface.

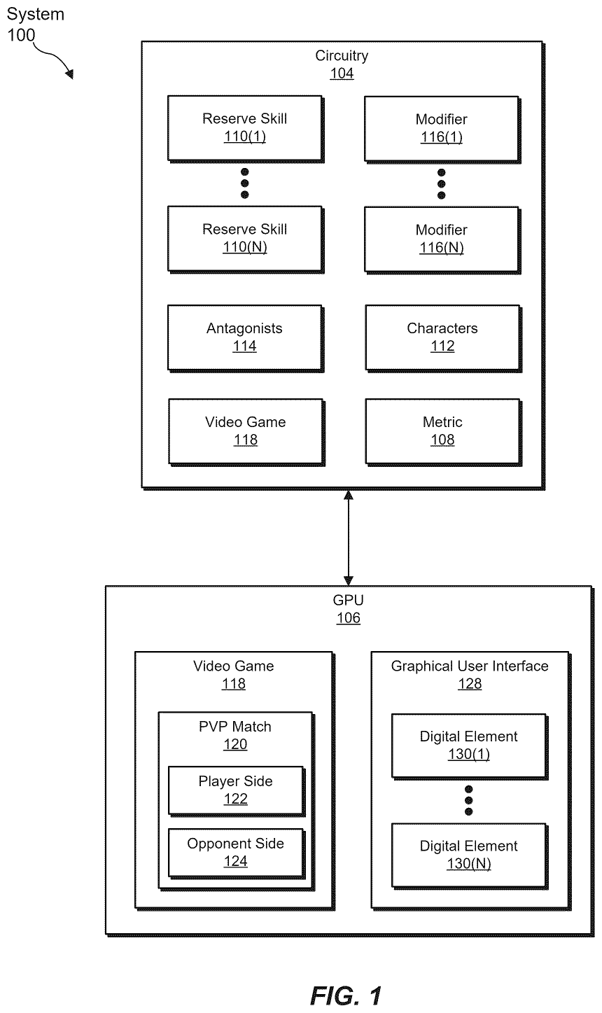

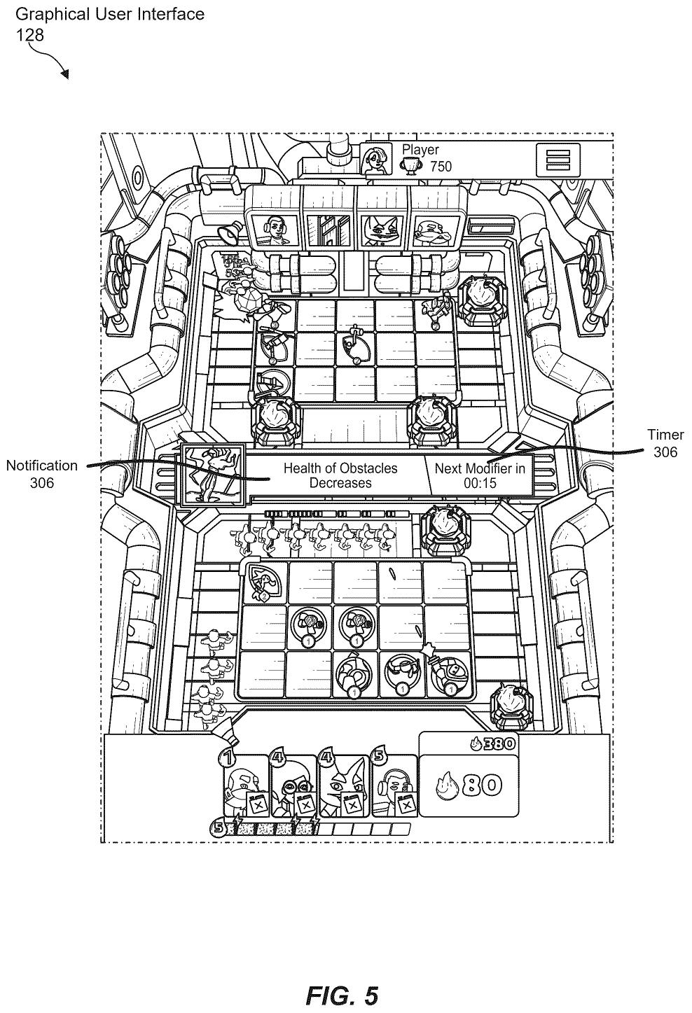

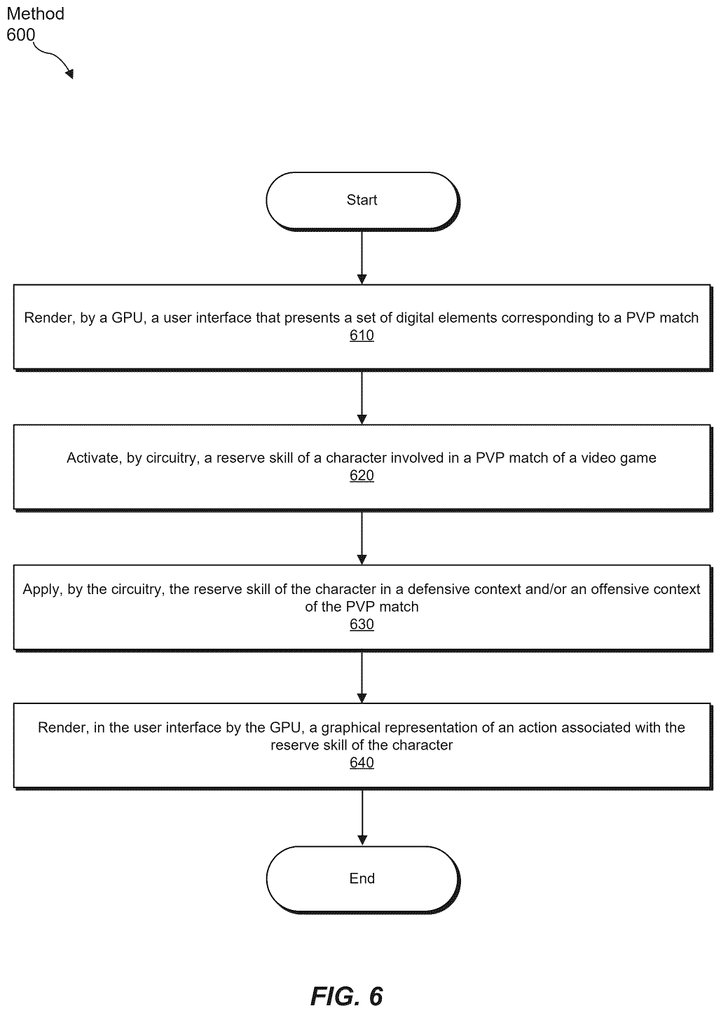

The following will provide, with reference to FIGS. 1-5 and 7-9, detailed descriptions of exemplary apparatuses, devices, systems, components, and corresponding configurations or implementations for activating and displaying features in PVP matchups. In addition, detailed descriptions of methods for activating and displaying features in PVP matchups will be provided in connection with FIG. 6.

FIG. 1 illustrates an exemplary system 100 for activating and displaying features in PVP matchups. As illustrated in FIG. 1, system 100 may include and/or represent circuitry 104 and GPU 106. In some examples, circuitry 104 may activate one or more reserve skills 110(1)-(N) of characters 112 involved in a PVP match 120 of a video game 118. For example, circuitry 104 may make reserve skills 110(1)-(N) available for use by certain characters and/or corresponding players at certain moments during PVP match 120. In one example, characters 112 may constitute and/or represent a team controlled by a player controlling one side of PVP match 120. In this example, PVP match 120 may include and/or represent a player side 122 controlled by a human player and/or an opponent side 124 controlled by another human player or a bot player.

In some examples, GPU 106 may render a graphical user interface 128 that presents digital elements 130(1)-(N) corresponding to PVP match 120. Additionally or alternatively, GPU 106 may render, in graphical user interface 128, graphical representations of actions (e.g., attacks, defenses, mergers of characters and/or their skillsets, survival tactics, etc.) associated with reserve skills 110(1)-(N) of characters 112.

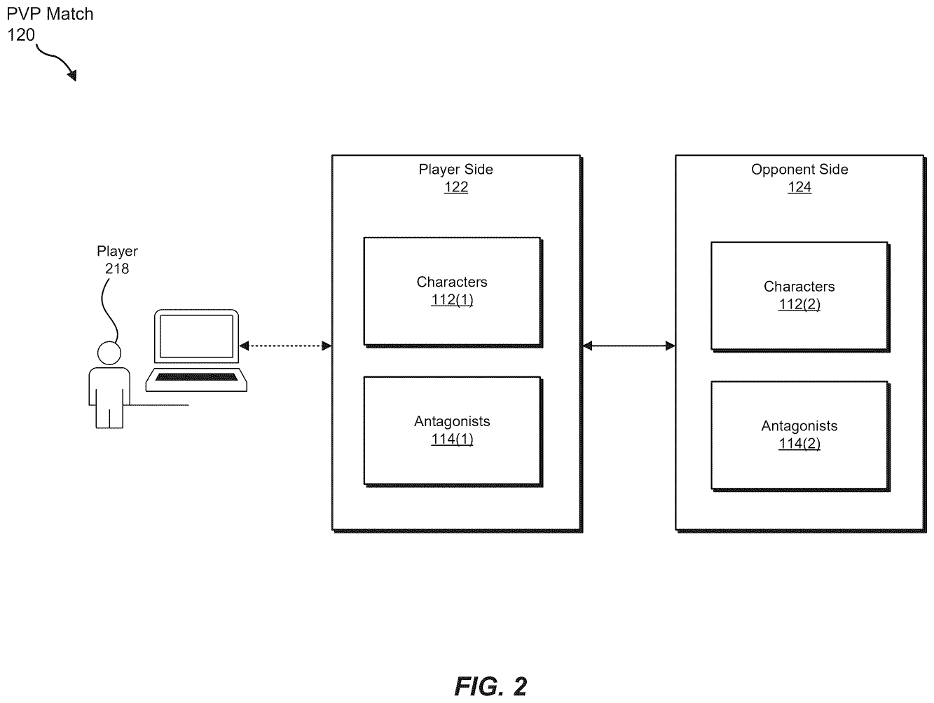

In some examples, circuitry 104 may apply and/or implement reserve skills 110(1)-(N) of characters 112 in PVP match 120 based at least in part on input received from a player (e.g., player 218 in FIG. 2) controlling characters 112. For example, the player may notice the moment when reserve skill 110(1) becomes available to one of characters 112 and then initiate reserve skill 110(1) for use by the character in PVP match 120 via user input. In this example, circuitry 104 may receive the user input provided by the player and then perform and/or implement an action associated with reserve skill 110(1) within PVP match 120. In certain implementations, GPU 106 may render one or more graphical representations of the action in graphical user interface 128.

In some examples, reserve skills 110(1)-(N) may be activated and/or become available for use based at least in part on one or more metrics related to and/or associated with one or more of characters 112 and/or the player controlling characters 112. For example, circuitry 104 may increment and/or increase a metric 108 associated with one or more of characters 112 based at least in part on the performance of the player in PVP match 120, the merging of characters, and/or the passage of time. In this example, GPU 106 may render a graphical representation of metric 108 in graphical user interface 128 for display to the player.

In some examples, circuitry 104 may determine and/or detect that metric 108 has reached and/or satisfied a certain threshold representative of the moment at which the player earns one or more of reserve skills 110(1)-(N) in PVP match 120. In one example, circuitry 104 may activate reserve skill 110(1) of one of characters 112 for use in response to metric 108 reaching and/or satisfying that threshold. In this example, circuitry 104 prevent reserve skill 110(1) from being used by that character prior to metric 108 reaching and/or satisfying the threshold. In certain implementations, circuitry 104 may reset metric 108 and/or decrease metric 108 to fall below the threshold, thereby withdrawing reserve skill 110(1) from repeat use by that character until metric 108 reaches and/or satisfies the threshold again during PVP match 120.

In some examples, circuitry 104 may apply and/or implement reserve skills 110(1)-(N) in a defensive context intended to prolong and/or extend the duration of survival for characters 112 and/or player side 122. In such examples, player side 122 may include and/or represent characters 112 controlled by the player, and/or opponent side 124 may include and/or represent one or more additional characters controlled by another player (whether a human or a bot). In one example, GPU 106 may render, in graphical user interface 128, one or more antagonists 114 that move, travel, and/or traverse along a lane and/or track on player side 122 of PVP match 120. Additionally or alternatively, circuitry 104 may enable the player to prolong the duration of survival for one or more of characters 112 and/or player side 122 by utilizing and/or implementing one or more of reserve skills 110(1)-(N) against one or more of antagonists 114 in PVP match 120.

In some examples, circuitry 104 may apply and/or implement reserve skills 110(1)-(N) in an offensive context intended to reduce and/or decrease the duration of survival for opponent side 124. In one example, GPU 106 may render, in graphical user interface 128, one or more additional antagonists that move, travel, and/or traverse along a lane on opponent side 124 of PVP match 120. Additionally or alternatively, circuitry 104 may enable the player to reduce the duration of survival for one or more the additional characters and/or opponent side 124 by utilizing and/or implementing one or more of reserve skills 110(1)-(N) against one or more of the additional antagonists in PVP match 120.

In some examples, the objective of video game 118 may be for player side 122 to survive longer than opponent side 124 in PVP match 120. In one example, player side 122 may lose and thus fail to survive longer than opponent side 124 if one or more of antagonists 114 reach and/or advance to a certain target and/or goal in, along, and/or at the end of the lane on player side 122 before one or more of the additional antagonists reach and/or advance to a certain target and/or goal in, along, and/or at the end of the lane on opponent side 124. Conversely, player side 122 may win and thus survive longer than opponent side 124 if one or more of the additional antagonists reach and/or advance to a certain target and/or goal in, along, and/or at the end of the lane on opponent side 124 before one or more of antagonists 114 reach and/or advance to a certain target and/or goal in, along, and/or at the end of the lane on player side 122.

In some examples, in the defensive context, the utilization and/or implementation of reserve skills 110(1)-(N) may cause characters 112 to delay and/or slow the advance of antagonists 114 along the lane on player side 122 of PVP match 120. For example, when implemented, reserve skill 110(1) may enable one of characters 112 to more aggressively and/or effectively defend against the advance of antagonists 114 along the lane of player side 122. Additionally or alternatively, in the offensive context, the utilization and/or implementation of reserve skills 110(1)-(N) may cause characters 112 to expedite and/or speed up the advance of the additional protagonists along the lane on opponent side 124 of PVP match 120. For example, when implemented, reserve skill 110(N) may enable the additional antagonists to more aggressively and/or effectively march and/or advance toward the target and/or goal at the end of the lane on opponent side 124.

In some examples, one or more of reserve skills 110(1)-(N) may be applied and/or implemented in both the defensive context and the offensive context. For example, circuitry 104 may enable the player to utilize reserve skill 110(1) of one of characters 112 against the advance of antagonists 114 and in favor of the advance of the additional antagonists. By doing so, the player may be able to both prolong the duration of survival for player side 122 and reduce the duration of survival for opponent side 124 in PVP match 120.

In some examples, circuitry 104 may randomly select one of modifiers 116(1)-(N) that is applicable to a feature of PVP match 120. In one example, circuitry 104 and/or GPU 106 may apply and/or implement the randomly selected modifier to one or more of digital elements 130(1)-(N) to dynamically change a graphical representation of the feature in graphical user interface 128. In this example, circuitry 104 and/or GPU 106 may apply and/or implement the randomly selected modifier at a predetermined time within PVP match 120. Examples of such a feature include, without limitation, one or more of characters 112 on player side 122, antagonists 114 on player side 122, the characters on opponent side 124, the antagonists on opponent side 124, obstructions that impede antagonists 114, obstructions that impede the antagonists on opponent side 124, combinations or variations of one or more of the same, and/or any other suitable features graphically represented in graphical user interface 128.

In some examples, modifiers 116(1)-(N) may last for a limited amount of time during PVP match 120. In such examples, GPU 106 may terminate and/or stop the application of modifiers 116(1)-(N) after the limited amount of time has lapsed during PVP match 120. For example, once the predetermined time for modifier 116(1) occurs during PVP match 120, GPU 106 may apply and/or implement modifier 116(1) by altering one or more of digital elements 130(1)-(N) to dynamically change the graphical representation of the feature corresponding to modifier 116(1) in graphical user interface 128. In this example, upon completion and/or passage of the limited amount of time that modifier 116(1) is to last, GPU 106 may dynamically return such digital elements to their previous and/or unaltered state.

In some examples, circuitry 104 and/or GPU 106 may reapply and/or reimplement modifier 116(1) to one or more of digital elements 130(1)-(N) during PVP match 120. Additionally or alternatively, circuitry 104 and/or GPU 106 may periodically reapply modifier 116(1) to one or more of digital elements 130(1)-(N) at predetermined times during PVP match 120. In one example, circuitry 104 and/or GPU 106 may apply modifier 116(1) to one or more of digital elements 130(1)-(N) at a predetermined time during PVP match 120. In this example, circuitry 104 and/or GPU 106 may apply modifier 116(N) to one or more of digital elements 130(1)-(N) at a subsequent predetermined time during PVP match 120.

In some examples, the predetermined time may correspond to, be reflected in, and/or be represented by a timer implemented in connection with PVP match 120. For example, circuitry 104 may implement a timer that counts down from a certain moment until the next mid-match modifier is applied by GPU 106. In this example, GPU 106 may render, present, and/or display a graphical representation of this timer in graphical user interface 128 to provide notice of the next mid-match modifier to the player. In certain implementations, graphical user interface 128 may include and/or represent the graphical representation of the timer along with a notification and/or a graphical representation of the mid-match modifier to be applied once the timer completes its countdown.

In some examples, circuitry 104 may include and/or represent one or more electrical and/or electronic circuits capable of processing, applying, modifying, transforming, displaying, transmitting, receiving, and/or executing data for system 100. Circuitry 104 may be communicatively and/or electrically coupled to GPU 106. In one example, circuitry 104 may access and/or analyze data stored in memory to facilitate and/or support activating and/or displaying features in PVP matches. Additionally or alternatively, circuitry 104 may launch, perform, and/or execute certain executable files, code snippets, and/or computer-readable instructions to facilitate and/or support activating and displaying features in PVP matchups. In certain implementations, circuitry 104 may provide GPU 106 with instructions and/or commands that, upon execution, cause GPU 106 to present and/or modify graphical user interface 128 in accordance with the progression of video game 118.

Although illustrated as a single unit in FIG. 1, circuitry 104 may include and/or represent a collection of multiple processing units and/or electrical or electronic components that work and/or operate in conjunction with one another. In one example, circuitry 104 may include and/or represent a central processing unit (CPU). In another example, circuitry 104 may include and/or represent an application-specific integrated circuit (ASIC). In certain implementations, circuitry 104 may be included and/or incorporated in a server and/or one or more client devices of system 100. Examples of circuitry 104 include, without limitation, processing devices, microprocessors, microcontrollers, graphics processing units (GPUs), field-programmable gate arrays (FPGAs), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, and/or any other suitable circuitry.

In some examples, GPU 106 may include and/or represent one or more hardware devices and/or electrical or electronic circuits capable of processing, generating and/or rendering graphical representations (e.g., GUIs, graphics, graphical and/or visual elements, etc.) for presentation on one or more displays, monitors, and/or graphics screens. In one example, GPU 106 may deliver and/or provide such graphical representations to the displays, monitors, and/or graphics screens in connection with video game 118. In certain implementations, GPU 106 may be included and/or incorporated in a server and/or one or more client devices of system 100.

In some examples, video game 118 may correspond to, represent, and/or provide a PVP matchup that includes and/or involves at least two different players that compete against each other in a direct way and/or an indirect way. For example, rather than fighting against each other in video game 118, the players may fight against different sets of antagonists within their respective in-game environments, arenas, and/or boards. In this example, video game 118 may establish playable characters (e.g., protagonists and/or heroes), selectable pieces, maps, antagonists, or interactive elements within those in-game environments, arenas, and/or boards. The in-game environments may include and/or represent the maps, enemies, and/or interactive elements with which the playable characters or selectable pieces interact (by, e.g., fighting, etc.). In some cases, the playable characters and/or selectable pieces may be strategically used to fight against the enemies and/or interactive elements, thus pitting the players against their respective in-game environments. Thus, a PVP matchup may include multiple virtual boards, where each virtual board involves a player facing off against their own in-game environment with the possibility of interaction and/or alteration by the opposing player.

In some examples, each in-game environment may include and/or represent one or more antagonists (e.g., minions, zombies, and/or enemies) that proceed along a lane and/or track from an inlet and/or a source to an outlet, goal, and/or destination (e.g., a gate or castle). As a player faces off against the antagonists within the corresponding in-game environment, the player may receive or otherwise have access to characters, champions, heroes, titans, and/or other digital elements with special skills, abilities, and/or functions. In one example, the player may decide how those digital elements with special skills and/or abilities are placed within their environment. Additionally or alternatively, the player may further decide which skills and/or abilities are used, which powerups and/or level-ups are applied, whether to purchase additional elements, and/or how those elements are upgraded.

In some examples, these digital elements with special skills and/or abilities may become overly powerful relative to a given environment and/or relative to another player who is playing against their own in-game environment. In such examples, circuitry 104 may modify or adjust the difficulty levels and/or strengths associated with the antagonists or other elements involved in PVP match 120 based at least in part on the ratings and/or rankings of the players. In one example, circuitry 104 may dynamically update and/or modify the level of difficulty associated with the antagonists over time (e.g., after completing certain rounds) within video game 118. For example, circuitry 104 may perform such dynamic modifications each round, each matchup, and/or on a periodic (e.g., hourly, daily, weekly) basis. In certain implementations, modifying and/or selecting the level of difficulty associated with and/or applied to the antagonists may include and/or involve dynamically changing one or more characteristics of the antagonists. Examples of such characteristics include damage levels, armor levels, health levels, combinations or variations of one or more of the same, and/or any other suitable characteristics.

In some examples, changes to the level of difficulty may apply regardless of whether the player is a human player, a bot player, or an artificial intelligence (AI) player (e.g., an AI bot). In one example, bots may be trained via a training data set to play like human players. In this example, such bots may exhibit and/or demonstrate various levels of skill and/or performance versus human players and/or enemies in different environments.

In some examples, video game 118 may include and/or involve synchronous and/or simultaneous playing in PVP match 120. In one example, circuitry 104 may facilitate and/or support synchronous and/or simultaneous playing in PVP match 120 such that the players directly and/or indirectly compete against each other in view of their respective performances. In certain implementations, circuitry 104 may determine and/or identify the winning player as the one who performs better against the corresponding antagonists in PVP match 120. For example, the winning player may be the one who prevents the corresponding antagonists from reaching their target and/or goal for the longest amount of time.

In some examples, the player's experience may be less enjoyable and/or impaired if PVP match 120 lasts too long. Moreover, the performance of system 100 and/or its underlying components may be impaired and/or weakened if the durations of the PVP matches across the entire userbase last too long. In this case, the durations of such PVP matchups may impose a certain workload and/or bandwidth requirement on system 100. If system 100 is scaled to support several instances of PVP matchups and/or video game 118 simultaneously, the workload and/or bandwidth requirement imposed by extending the overall duration of one or more of those PVP matches may impair and/or weaken the performance of system 100 not only for those PVP matches but also for other PVP matchups and/or other instances of video game 118 hosted by system 100 or the corresponding network.

To address and/or solve these technological problems, system 100 may implement certain features and/or functions to align, equalize, standardize, and/or shorten the overall duration of the PVP matchup. For example, circuitry 104 may identify a target and/or ideal duration of PVP match 120. In one example, circuitry 104 may select a level of difficulty to be applied to the antagonists involved in PVP match 120 based at least in part on the target and/or ideal duration as well as the players' respective ratings.

In some examples, PVP match 120 may include and/or represent multiple rounds, stages, and/or levels of play. In one example, circuitry 104 may detect an end of a round in one of PVP match 120. In this example, circuitry 104 may increase the level of difficulty associated with and/or applied to the characters involved in PVP match 120 prior to the start of a subsequent round.

In some examples, reserve skills 110(1)-(N) may each include and/or represent any type or form of skill, ability, move, weapon, attack, and/or defense that is available for use by one or more of characters 112 only under certain circumstances. For example, reserve skills 110(1)-(N) may be unavailable during a first portion of PVP match 120 and may then become available when certain criteria are met (e.g., once metric 108 reaches a certain threshold). Examples of reserve skills 110(1)-(N) include, without limitation, increased damage capabilities, increased armor capabilities, increased health, increased recovery potential, merging abilities of different characters, leveling up and/or amplifying abilities of characters, new or different weapons, new or different attacks or defenses, forcing antagonists to respawn on the opponent's side of a PVP match, combinations or variations of one or more of the same, and/or any other suitable reserve skills.

In some examples, modifiers 116(1)-(N) may each include and/or represent any type or form of modification, alteration, and/or change made to digital elements 130(1)-(N) and/or features of graphical user interface 128 and/or video game 118 during PVP match 120. For example, digital elements 130(1)-(N) and/or the corresponding feature may be configured and/or presented in an initial state during the first portion of PVP match 120. In this example, upon application and/or implementation of modifier 116(1) at a predetermined time, one or more of digital elements 130(1)-(N) and/or the corresponding feature may be altered and/or changed from the initial state to a subsequent state. In certain implementations, upon expiration of modifier 116(1), such digital elements and/or the corresponding feature may return from the subsequent state to the initial state. In other implementations, modifier 116(1) may last indefinitely and/or permanently, thereby causing digital elements 130(1)-(N) and/or the corresponding feature to remain in the subsequent state for the rest of PVP match 120.

Examples of modifiers 116(1)-(N) include, without limitation, sudden death and/or elimination of obstructions on player side 122 or opponent side 124, increased or decreased numbers of antagonists on player side 122 or opponent side 124, increased or decreased health levels of antagonists on player side 122 or opponent side 124, increased or decreased speeds of antagonists on player side 122 or opponent side 124, expedited leveling-up abilities and/or promotions for characters on player side 122 or opponent side 124, increased or decreased credits and/or scores for players involved in PVP match 120, increased or decreased numbers of characters on player side 122 or opponent side 124, increased or decreased strength and/or abilities of characters on player side 122 or opponent side 124, sudden death and/or elimination of antagonists on player side 122 or opponent side 124, explosions resulting from the death and/or elimination of antagonists on player side 122 or opponent side 124, protagonists eliminated on player side 122 respawn on opponent side 124, protagonists eliminated on opponent side 124 respawn on player side 122, combinations or variations of one or more of the same, and/or any other suitable modifiers.

In some examples, the various systems, components, and/or features described in connection with FIG. 1 may include and/or represent one or more additional circuits, components, and/or features that are not necessarily illustrated and/or labeled in FIG. 1. For example, the systems, components, and/or features illustrated in FIG. 1 may also include and/or represent additional analog and/or digital circuitry, onboard logic, transistors, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, combinations or variations of one or more of the same, and/or any other suitable components. In certain implementations, one or more of these additional circuits, components, and/or features may be inserted and/or applied between any of the existing circuits, components, and/or features illustrated in FIG. 1 consistent with the aims and/or objectives described herein. Accordingly, the couplings and/or connections described with reference to FIG. 1 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

FIG. 2 illustrates an exemplary implementation of PVP match 120, which involves player side 122 and opponent side 124. In some examples, player side 122 of PVP match 120 may be controlled and/or managed by a player 218. In one example, player 218 may constitute and/or represent a human operating a client device in communication with a server that coordinates player side 122 and opponent side 124. In this example, opponent side 124 of PVP match 120 may be controlled and/or managed by another player (e.g., another human, a bot, and/or an AI).

In some examples, player side 122 of PVP match 120 may include and/or represent characters 112(1) and/or antagonists 114(1). In one example, characters 112(1) may face off and/or defend against antagonists 114(1) on player side 122. Additionally or alternatively, opponent side 124 of PVP match 120 may include and/or represent characters 112(2) and/or antagonists 114(2). In one example, characters 112(2) may face off and/or defend against antagonists 114(2) on opponent side 124.

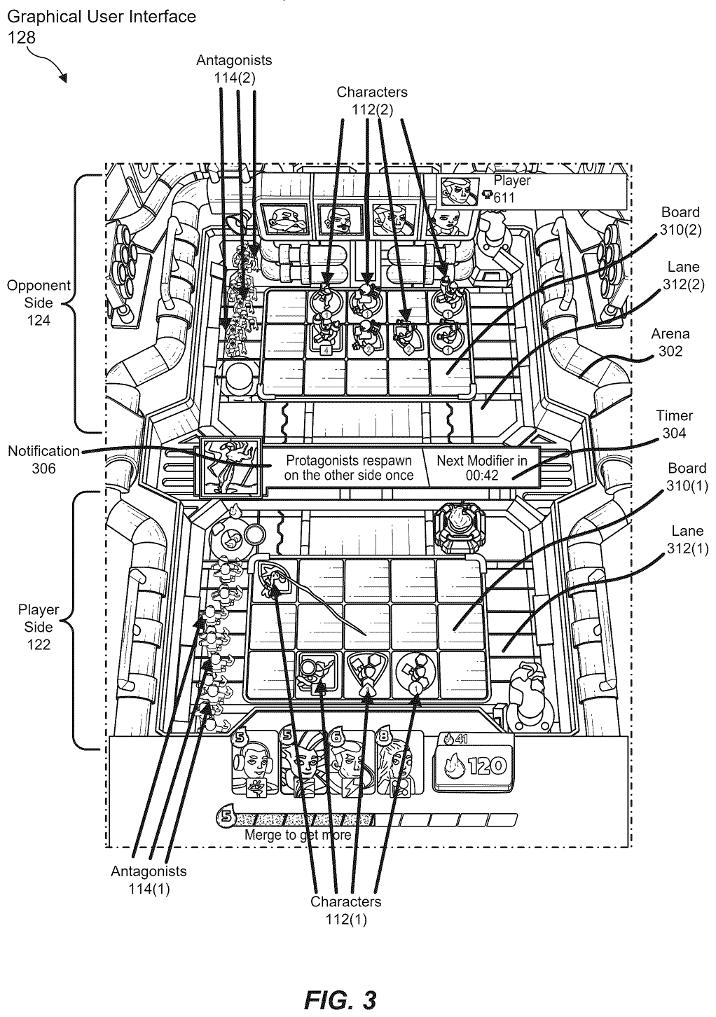

FIGS. 3-5 illustrates exemplary implementations of graphical user interface 128, which includes digital elements of video game 118 for presentation to one or more players involved in PVP match 120. In some examples, graphical user interface 128 may include and/or represent certain elements, components, and/or features that perform and/or provide functionalities that are similar and/or identical to those described above in connection with FIG. 1 and/or FIG. 2. As illustrated in FIGS. 3-5, graphical user interface 128 may include and/or represent a map and/or an arena 302 that is bisected into two different in-game environments dedicated to and/or reserved for player side 122 and/or opponent side 124 of PVP match 120. In one example, graphical user interface 128 may include and/or represent player side 122 on the bottom and/or lower part of arena 302. In this example, graphical user interface 128 may also include and/or represent opponent side 124 on the top and/or upper part of arena 302.

In some examples, player side 122 may include and/or represent a board 310(1) on which characters 112(1) are placed and/or configured for defending against antagonists 114(1). In one example, player side 122 may also include and/or represent a lane 312(1) along which antagonists 114(1) traverse and/or move toward their target, goal, and/or objective. In this example, player side 122 may also include and/or represent one or more obstructions 408(1) placed and/or configured along lane 312(1) to slow and/or impede antagonists 114(1) from reaching and/or achieving their target, goal, and/or objective.

In some examples, opponent side 124 may include and/or represent a board 310(2) on which characters 112(2) are placed and/or configured for defending against antagonists 114(2). In one example, opponent side 124 may also include and/or represent a lane 312(2) along which antagonists 114(2) traverse and/or move toward their target, goal, and/or objective. In this example, opponent side 124 may also include and/or represent one or more obstructions 408(2) placed and/or configured along lane 312(2) to slow and/or impede antagonists 114(2) from reaching and/or achieving their target, goal, and/or objective.

In some examples, graphical user interface 128 may include and/or show a graphical representation of timer 304 that indicates and/or identifies the predetermined time at which the next modifier will be applied and/or implemented in PVP match 120. Additionally or alternatively, graphical user interface 128 may include and/or represent a notification 306 that indicates and/or identifies the next modifier to be applied and/or implemented at the predetermined time represented by timer 304. In one example, the graphical representation of timer 304 and notification 306 may be placed and/or arranged between player side 122 and opponent side 124 within graphical user interface 128.

In some examples, graphical user interface 128 may include and/or show a metric 404 associated with characters 112(1). In one example, metric 404 may reflect and/or indicate the ability of player 218 to apply, implement, and/or utilize reserve skills 110(1)-(N) of characters 112(1). In this example, when metric 404 reaches and/or satisfies one or more of thresholds 402, player 218 may be able to apply, implement, and/or utilize the reserve skill of any of the characters unlocked and/or activated by metric 404.

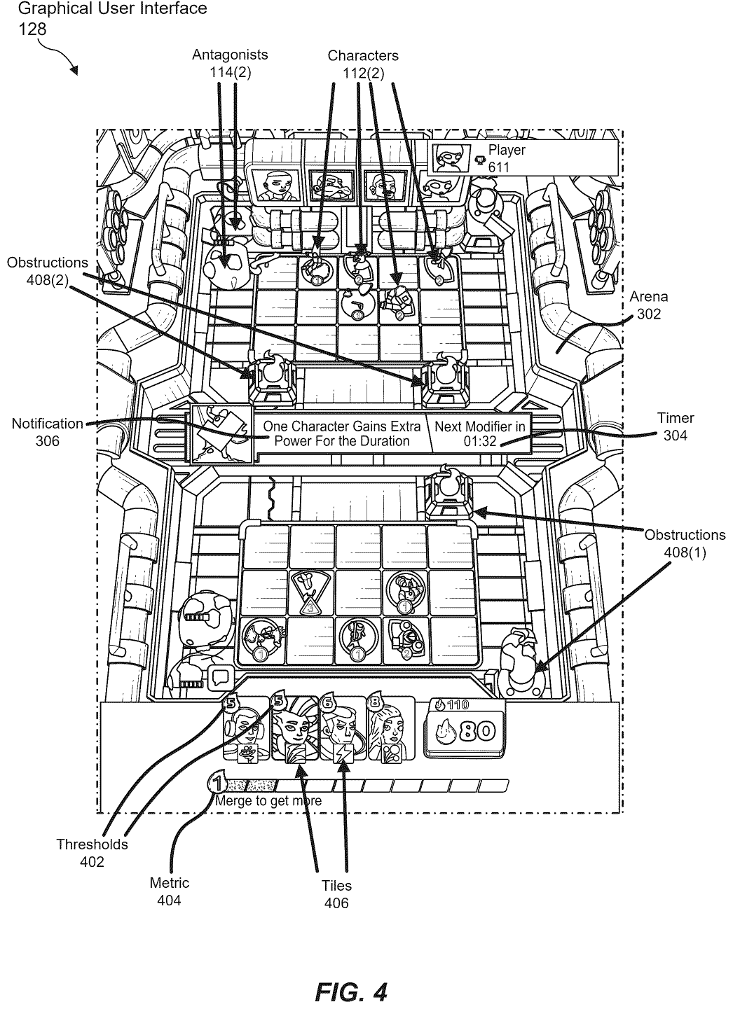

As a specific example, graphical user interface 128 may include and/or show a set of tiles 406 that correspond to and/or represent characters 112(1). In this example, thresholds 402 may be presented and/or shown proximate to tiles 406 to indicate and/or identify the level and/or score that metric 404 must reach to unlock and/or activate reserve skills 110(1)-(N) of characters 112(1). For example, and as illustrated in FIG. 4, metric 404 may need to reach a level of “5” to unlock and/or activate the reserve skills of two of characters 112(1). In this example, metric 404 may need to reach a level of “6” to unlock and/or activate the reserve skill of another one of characters 112(1), and metric 404 may need to reach a level of “8” to unlock and/or activate the reserve skill of an additional one of characters 112(1).

FIG. 6 is a flow diagram of an exemplary computer-implemented method 600 for activating and displaying features in PVP matchups. In one example, the steps shown in FIG. 6 may be achieved and/or accomplished by a networked gaming system (e.g., a server-client computing system and/or architecture). Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of rendering, by a GPU, a user interface that presents a set of digital elements corresponding to a PVP match of a video game (610). Step 610 may be performed in a variety of ways, including any of those described above in connection with FIGS. 1-5. For example, a GPU incorporated in a server and/or a client device may render a user interface that presents a set of digital elements corresponding to a PVP match of a video game.

Method 600 may also include the step of activating, by circuitry, a reserve skill of a character involved in the PVP match (620). Step 620 may be performed in a variety of ways, including any of those described above in connection with FIGS. 1-5. For example, circuitry incorporated in the server and/or the client device may activate a reserve skill of a character involved in the PVP match.

Method 600 may further include the step of applying, by the circuitry, the reserve skill of the character in a defensive context and/or an offensive context of the PVP match (630). Step 630 may be performed in a variety of ways, including any of those described above in connection with FIGS. 1-5. For example, circuitry incorporated in the server and/or the client device may apply the reserve skill of the character in a defensive context and/or an offensive context of the PVP match. In this example, the defensive context may be intended and/or designed to prolong the duration of survival for a player side of the PVP match that involves the character. Additionally or alternatively, the offensive context may be intended and/or designed to reduce the duration of survival for an opponent side of the PVP match that does not directly involve the character.

Method 600 may further include the step of rendering, in the user interface, a graphical representation of an action associated with the reserve skill of the character (640). Step 640 may be performed in a variety of ways, including any of those described above in connection with FIGS. 1-5. For example, a GPU incorporated in the server and/or the client device may render, in the user interface, a graphical representation of an action associated with the reserve skill of the character.

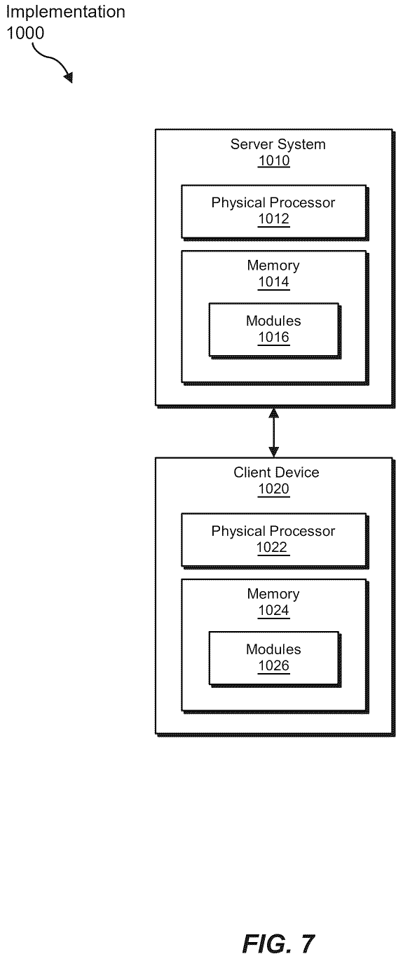

In some examples, system 100 in FIG. 1 may be implemented and/or deployed in various computing configurations and/or architectures, such as server-client configuration and/or architectures. FIG. 7 illustrates an exemplary implementation 1000 of a server-client architecture that includes a server system 1010 and a client device 1020 in communication with one another (e.g., over a network). In one example, server system 1010 is configured to encode data at a specific data rate and to transfer the encoded data to client device 1020. Client device 1020 is configured to receive the encoded data via server system 1010 and to decode the data for presentation and/or playback for a player and/or user. The data provided by server system 1010 includes, for example, audio, video, text, images, animations, interactive content, haptic data, virtual or augmented reality data, location data, gaming data, or any other type of data that is provided via streaming.

Server system 1010 generally represents any services, hardware, software, or other infrastructure components configured to deliver gaming content to players. For example, server system 1010 includes content aggregation systems, media transcoding and packaging services, network components, and/or a variety of other types of hardware and software. In some cases, server system 1010 is implemented as a highly complex distribution system, a single media server or device, or anything in between. In some examples, regardless of size or complexity, server system 1010 includes at least one physical processor 1012 and at least one memory 1014. One or more modules 1016 are stored or loaded into memory 1014 to enable adaptive streaming, as discussed herein.

Client device 1020 generally represents any type or form of device or system capable of playing audio and/or video content that has been provided by server system 1010. Examples of client device 1020 include, without limitation, gaming platforms, mobile phones, tablets, laptop computers, desktop computers, televisions, set-top boxes, digital media players, virtual reality headsets, augmented reality glasses, and/or any other type or form of device capable of rendering digital content. As with server system 1010, client device 1020 includes a physical processor 1022, memory 1024, and one or more modules 1026. Some or all of the adaptive streaming processes described herein is performed or enabled by modules 1026, and in some examples, modules 1016 of server system 1010 coordinate with modules 1026 of client device 1020 to provide adaptive streaming of multimedia gaming content.

In certain embodiments, one or more of modules 1016 and/or 1026 in FIG. 7 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia gaming content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

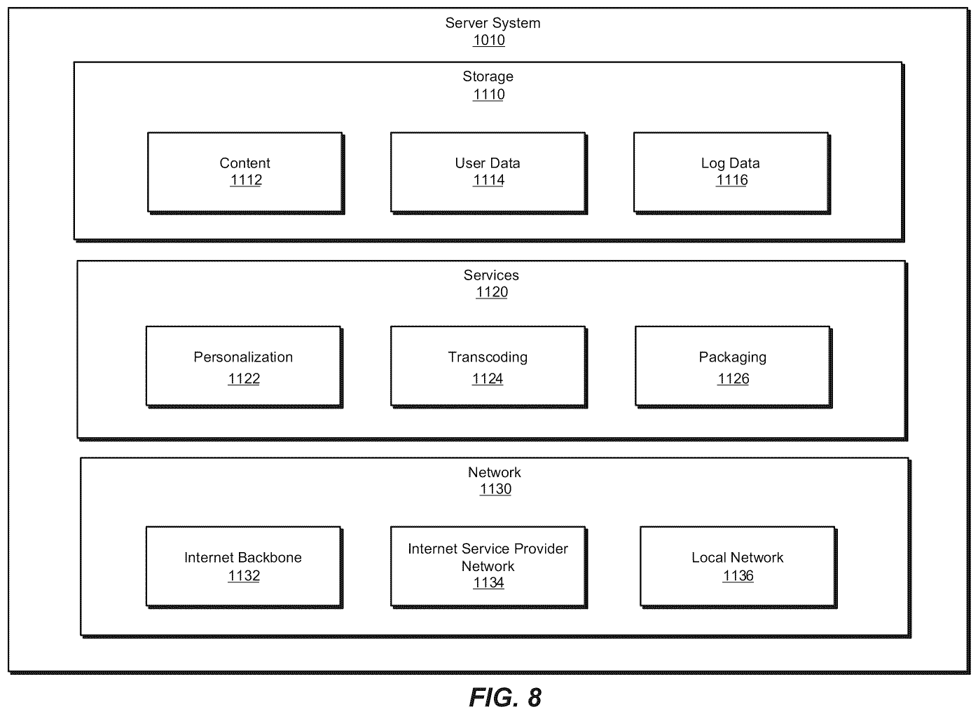

FIG. 8 is a block diagram of exemplary components of server system 1010 according to certain embodiments. Server system 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes video games, GUIs, user-generated content, and/or any other suitable type or form of content. User data 1114 includes personally identifiable information (PII), payment information, preference settings, language and accessibility settings, and/or any other information associated with a particular user or content player. Log data 1116 includes gaming history information, network throughput information, and/or any other metrics associated with a player's connection to or interactions with server system 1010.

Services 1120 includes personalization services 1122, transcoding services 1124, and/or packaging services 1126. Personalization services 1122 personalize recommendations, content streams, and/or other aspects of a user's experience with server system 1010. Encoding services compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 1130 includes an Internet backbone 1132, an Internet service provider 1134, and/or a local network 1136. As discussed in greater detail below, bandwidth limitations and bottlenecks within one or more of these network segments triggers video and/or audio bit rate adjustments.

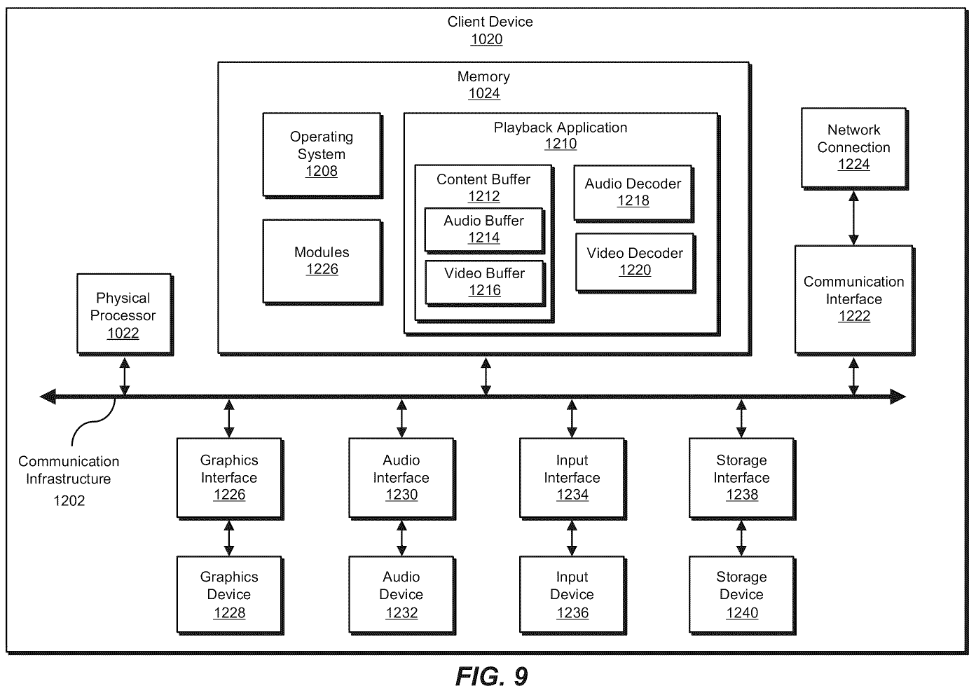

FIG. 9 is a block diagram of an exemplary implementation of client device 1020 in FIG. 7. As shown in FIG. 9, in addition to physical processor 1022 and memory 1024, client device 1020 includes a communication infrastructure 1202 and a communication interface 1222 coupled to a network connection 1224. Client device 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by physical processor 1022. In one example, operating system 1208 includes and/or represents software that manages computer hardware and software resources and/or provides common services to computer programs and/or applications on client device 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In some examples, playback application 1210 may receive a request from a user to play a specific video game. Playback application 1210 then identifies one or more encoded video and audio streams associated with the requested video game. After playback application 1210 has located the encoded streams associated with the requested title, playback application 1210 downloads sequence header indices associated with each encoded stream associated with the requested title from server system 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file may then be downloaded into content buffer 1212, which is configured to serve as a first-in, first-out queue. In one embodiment, each unit of downloaded data includes a unit of video data or a unit of audio data. As units of video data associated with the requested digital content file are downloaded to the client device 1020, the units of video data are pushed into the content buffer 1212. Similarly, as units of audio data associated with the requested digital content file are downloaded to the client device 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of server system 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with physical processor 1022. Alternatively, graphics interface 1226 is configured as a hardware accelerator that is distinct from (i.e., is not integrated within) a chipset that includes physical processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 9, client device 1020 also includes at least one input device 1236 coupled to communication infrastructure 1202 via input interface 1234. Input device 1236 generally represents any type or form of computing device capable of providing input, either computer or human generated, to client device 1020. Examples of input device 1236 include, without limitation, a controller, a keyboard, a pointing device, a speech recognition device, a touch screen, a joystick, a wearable device (e.g., a glove, a watch, etc.), variations or combinations of one or more of the same, and/or any other type or form of electronic input mechanism.

Client device 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of client device 1020.

Many other devices or subsystems are included in or connected to client device 1020. Conversely, one or more of the components and devices illustrated in FIG. 9 need not be present to practice the embodiments described and/or illustrated herein. The devices and subsystems referenced above are also interconnected in different ways from that shown in FIG. 9. Client device 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into client device 1020. All or a portion of the computer program stored on the computer-readable medium is then stored in memory 1024 and/or storage device 1240. When executed by physical processor 1022, a computer program loaded into memory 1024 causes physical processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, client device 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
circuitry configured to activate a reserve skill of a character involved in a player-versus-player (PVP) match of a video game; and
a graphics processing unit (GPU) configured to:
render a user interface that presents a set of digital elements corresponding to the PVP match; and
render, in the user interface, a graphical representation of an action associated with the reserve skill of the character.

2. The system of claim 1, wherein the circuitry is further configured to apply the reserve skill of the character in the PVP match based at least in part on input received from a player controlling the character.

3. The system of claim 1, wherein the circuitry is further configured to:
determine that a metric associated with the character has reached a certain threshold; and
activate the reserve skill of the character in response to the metric reaching the certain threshold.

4. The system of claim 3, wherein the circuitry is further configured to increase the metric associated with the character based at least in part on:
a performance of a player controlling the character; or
a passage of time.

5. The system of claim 1, wherein the circuitry is further configured to apply the reserve skill of the character in a defensive context intended to prolong a duration of survival for a player side of the PVP match that involves the character.

6. The system of claim 5, wherein:
the GPU is further configured to render, in the user interface, one or more antagonists that move along a lane on the player side of the PVP match; and
the circuitry is further configured to enable a player controlling the player side of the PVP match to prolong the duration of survival for the player side by utilizing the reserve skill of the character against the one or more antagonists that move along the lane on the player side.

7. The system of claim 1, wherein the circuitry is further configured to apply the reserve skill of the character in an offensive context intended to reduce a duration of survival for an opponent side of the PVP match that does not directly involve the character.

8. The system of claim 7, wherein:
the GPU is further configured to render, in the user interface, one or more antagonists that move along a lane on the opponent side of the PVP match; and
the circuitry is further configured to enable a player controlling a player side of the PVP match to reduce the duration of survival for the opponent side by utilizing the reserve skill of the character against the one or more antagonists that move along the lane on the opponent side.

9. The system of claim 1, wherein the circuitry is further configured to apply the reserve skill of the character in both:
a defensive context intended to prolong a duration of survival for a player side of the PVP match that involves the character; and
an offensive context intended to reduce a duration of survival for an opponent side of the PVP match that does not directly involve the character.

10. The system of claim 9, wherein:
the GPU is further configured to:
render, in the user interface, one or more antagonists that move along a lane on the player side of the PVP match; and
render, in the user interface, one or more additional antagonists that move along an additional lane on the opponent side of the PVP match; and
the circuitry is further configured to enable a player controlling the player side of the PVP match to utilize the reserve skill of the character against the one or more antagonists and in favor of the one or more additional antagonists to both prolong the duration of survival for the player side and reduce the duration of survival for the opponent side.

11. The system of claim 1, wherein:
the circuitry configured to activate an additional reserve skill of an additional character involved in the PVP match; and
the GPU is further configured to render, in the user interface, a graphical representation of an additional action associated with the additional reserve skill of the additional character.

12. The system of claim 1, wherein:
the circuitry is further configured to randomly select, from a set of modifiers, a modifier applicable to a feature of the PVP match; and
the GPU is further configured to apply, at a predetermined time within the PVP match, the modifier to one or more of the digital elements to dynamically change a graphical representation of the feature in the user interface.

13. The system of claim 12, wherein the feature of the PVP match comprises at least one of:
the character;
one or more antagonists on a player side of the PVP match that involves the character;
one or more antagonists on an opponent side of the PVP match that does not directly involve the character; or an obstruction that impedes one or more antagonists from achieving an objective.

14. The system of claim 12, wherein:
the modifier lasts for a limited amount of time during the PVP match; and
the GPU is further configured to terminate the modifier applied to the one or more of the digital elements after the limited amount of time has lapsed during the PVP match.

15. The system of claim 12, wherein the GPU is further configured to periodically reapply the modifier to the one or more of the digital elements during the PVP match.

16. The system of claim 15, wherein:
the circuitry is further configured to randomly select, from the set of modifiers, an additional modifier applicable to an additional feature of the PVP match; and
the GPU is further configured to:
apply the modifier to the one or more of the digital elements at the predetermined time within a specific round of the PVP match; and
apply the additional modifier to another one of the digital elements to dynamically change a graphical representation of the additional feature at another predetermined time within the specific round of the PVP match.

17. The system of claim 12, wherein the predetermined time corresponds to a countdown timer implemented in connection with the PVP match.

18. The system of claim 17, wherein the GPU is further configured to render, in the user interface, a graphical representation of the countdown timer along with a notification of the modifier to be applied to the one or more of the digital elements.

19. A computer-implemented method comprising:
rendering, by a graphics processing unit (GPU), a user interface that presents a set of digital elements corresponding to a player-versus-player (PVP) match of a video game;
activating, by circuitry, a reserve skill of a character involved in the PVP match;
applying, by the circuitry, the reserve skill of the character in at least one of:
a defensive context intended to prolong a duration of survival for a player side of the PVP match that involves the character; or
an offensive context intended to reduce a duration of survival for an opponent side of the PVP match that does not directly involve the character; and
rendering, in the user interface, a graphical representation of an action associated with the reserve skill of the character.

20. A non-transitory computer-readable medium comprising one or more computer-executable instructions that, when executed by at least one hardware processor of a computing device, cause the hardware processor to:
activate a reserve skill of a character involved in a player-versus-player (PVP) match of a video game;
apply the reserve skill of the character in at least one of:
a defensive context intended to prolong a duration of survival for a player side of the PVP match that involves the character; or
an offensive context intended to reduce a duration of survival for an opponent side of the PVP match that does not directly involve the character; and
direct a graphics processing unit (GPU) to:
render a user interface that presents a set of digital elements corresponding to the PVP match; and
render, in the user interface, a graphical representation of an action associated with the reserve skill of the character.
